(19) United States
(12) Patent Application Publication
(10) Pub. No.: US 2001/0019600 A1
(43) Pub. Date: Sep. 6, 2001

(54) Planar image detector for electromagnetic rays, particularly X-rays

(75) Inventor: Hartmut Sklebitz, Erlangen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 09/798,317

(22) Filed: Mar. 2, 2001

(30) Foreign Application Priority Data
Mar. 2, 2000 (DE) 10009954.8

(51) Int. Cl. H05G 1/44

(52) U.S. Cl. 378/108; 378/98.7; 378/37

(57) ABSTRACT

A planar image detector for electromagnetic rays producing an image for an examination subject has an active surface on a substrate with a matrix of radiation-sensitive pixel elements, and a radiation-sensitive sensor for generating control signals for an exposure control is arranged immediately next to the active area within the rays attenuated by the examination subject.

### BACKGROUND OF THE INVENTION

1. Field of the Invention

The present invention is directed to a planar image detector for electromagnetic rays for use in producing an image of an examination subject of the type having an active surface on a substrate with a matrix of radiation-sensitive pixel elements. Such image detectors are utilized, for example, in X-ray diagnostics installations and in X-ray apparatuses for mammography.

2. Description of the Prior Art

FIG. 1 shows an X-ray diagnostic installation disclosed by German OS-195 27 148 having an X-ray tube 2 supplied with high-voltage and filament voltage by a high-voltage generator 1, the X-ray tube 3 generates a conical X-ray beam 3 that penetrates a patient and produces a radiation image on an X-ray detector 5 that is sensitive for X-rays 3. The output signal of the X-ray detector 5—the image data 6—is supplied to an image system 7. The image system 7 can comprise converters, image memories and processing circuits. The image system 7 is connected to a monitor 8 for playback of the acquired X-ray images Operating elements 9 are connected to the other components of the X-ray diagnostic installation via a system control and communication unit 10.

FIG. 2 shows the X-ray detector 5 in a perspective cross-section. The core component of the X-ray detector 5 is composed of a solid-state pixel matrix, line drivers and amplifiers. The solid-state pixel matrix is composed, for example, of a layer with a scintillator composed, for example, of cesium iodide (CsI) that, given irradiation by the X-ray beam 3, supplies visible photons into a pixel matrix 12 of amorphous silicon that yield a visible X-ray image. Each of the pixels or picture elements of this pixel matrix 12, as shown magnified in FIG. 2, is composed of a photodiode 13 and a switch 14 that is connected to a row line 15 and a column line 16. The pixel matrix 12 is applied on a glass substrate 20.

All pixels of a line are simultaneously addressed and read out by the line drivers 17, The signals are processed in parallel in a number of amplifiers 18. In the simplest case, an image is read out progressively line-by-line.

When such an X-ray detector 5 is utilized in mammography, there is the problem of correctly placing a sensor for the exposure control. Because such a sensor causes too large an occlusion for soft X-rays, it cannot be arranged preceding the X-ray detector 5, as well-known from radiology. A placement following the X-ray detector S is also not possible since the X-ray absorption of the X-ray detector 5 is too high.

### SUMMARY OF THE INVENTION

An object of the present invention is to provide a planar image detector of the type initially described wherein a sensor for exposure control is arranged such that no occlusion ensues and the effective area for imaging is as large as possible. Moreover, the measurement should ensue at a location at which X-ray absorption exists that is approximately the same as under the examination subject.

This object is inventively achieved in a planar image detector having a radiation-sensitive sensor arranged immediately next to the active area of radiation-sensitive pixel elements for generating control signals for an exposure control and within the rays attenuated by the examination subject.

Given a planar image detector for imaging in an X-ray apparatus for marnmography, the radiation-sensitive sensor should be arranged centered at a lateral region close to the rib case, preferably between the image area and chest wall.

Inventively, the radiation-sensitive sensor can be a photoelement that is arranged in the middle of the chest wall-proximate lateral region. It can alternatively be formed by a number of photoelements that are arranged distributed in a row at the chest wall-proximate lateral region so that they lie within the region occluded by the examination subject.

It has proven advantageous when to correct circuit arrangement to the photoelements of the radiation-sensitive sensor that effects a selection of the output signals of the photoelements. inventively, the radiation-sensitive sensor can be arranged parallel, perpendicular or obliquely relative to the pixel matrix.

A simple structure of the radiation-sensitive sensor is obtained when each photoelement of the radiation-sensitive sensor is composed of a photodiode on which a scintillator is attached. Alternatively, the photoelements of the radiation-sensitive sensor can be composed of a photodiode onto which a photo semiconductor is applied. The photodiodes can be composed of crystalline silicon.

The layer with the pixel matrix can be composed of crystalline or amorphous silicon (aSi, aSi:H).

Inventively, a stray radiation grid can be attached preceding the radiation-sensitive sensor or a moving stray radiation grid can be allocated to the planar image detector.

### DESCRIPTION OF THE DRAWINGS

FIG. 1 shows a known X-ray diagnostics installation with an X-ray generator.

FIG. 2 is a perspective view of a known X-ray detector.

FIG. 3 shows an X-ray apparatus for mammography having an inventive X-ray detector;

FIGS. 4-6 is a cross-section through inventive X-ray detectors with exposure sensors.

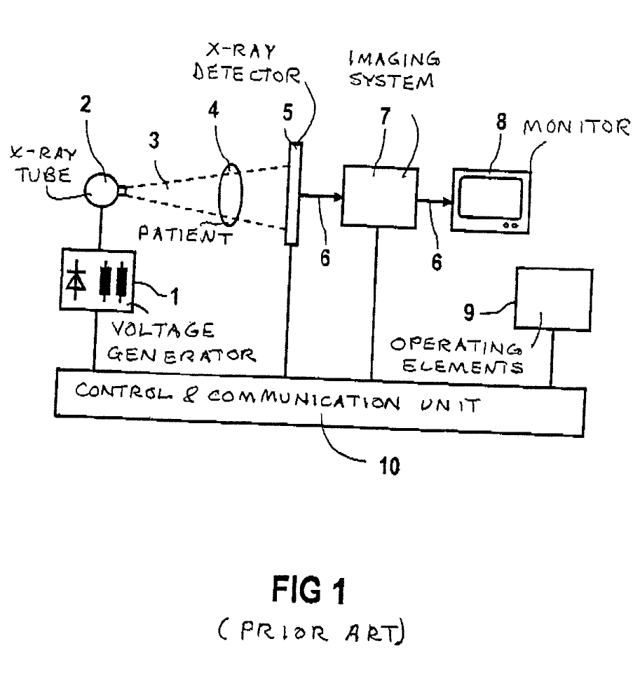

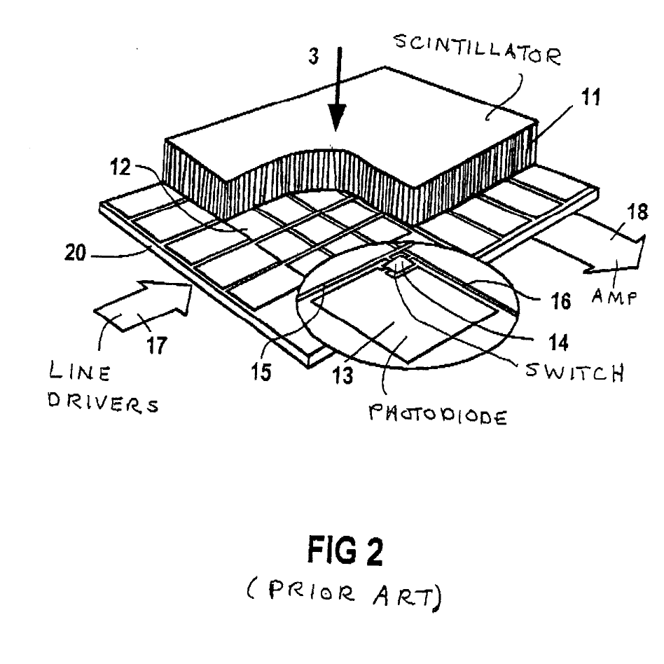

### DESCRIPTION OF THE PREFERRED EMBODIMENTS

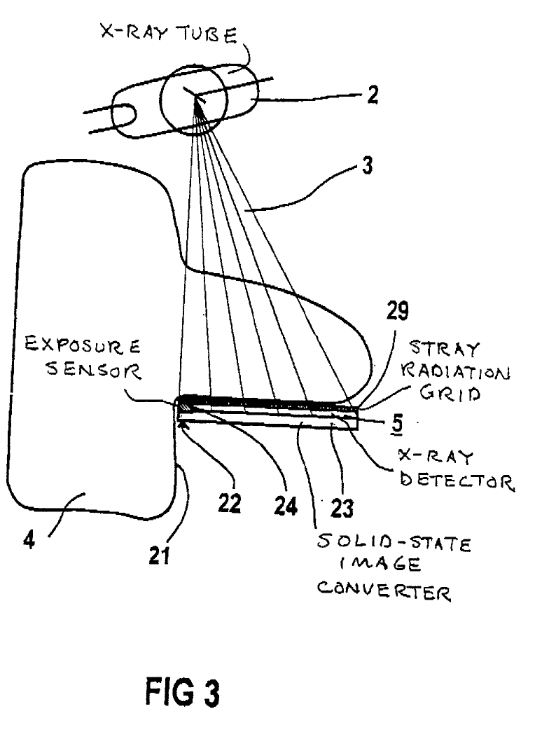

FIG. 3 shows an inventive X-ray diagnostic installation for mammographic exposures having an X-ray detector 5 that lies against the chest wall 21 of a patient, In the chest wall-proximate lateral region 22, the X-ray detector has an exposure sensor 24 preceding a solid-state image converter, the sensor 24 generating a control signal for the exposure control by the system controller 10. The X-ray detector 5 can have a stray radiation grid 29 that, as a fixed stray radiation grid, is either arranged only over the exposure sensor 24 or, as movable stray radiation grid 29, is arranged in front of the stray radiation grid 24 and the solid-state image converter 23.

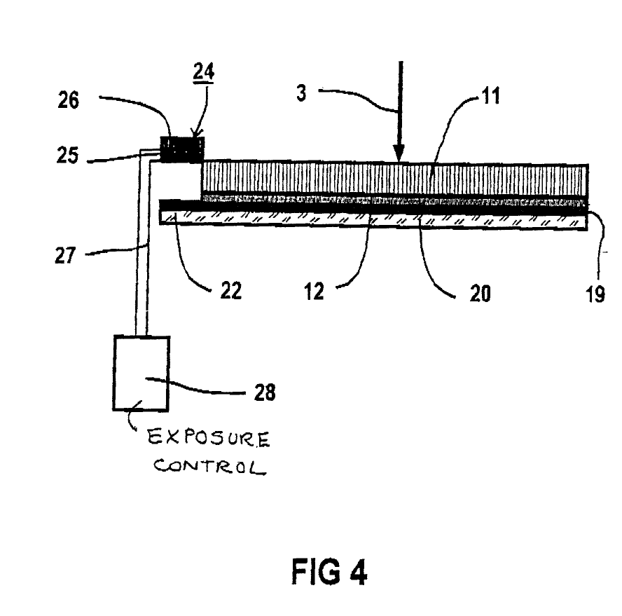

FIG. 4 shows the glass substrate 20 on which the terminal lines and/or contacts 19 are located. The pixel matrix 12, which is covered by the scintillator 11, lies thereabove. The chest wall-proximate lateral region 22 is thereby left open. The exposure sensor 24 is arranged at the region, and is composed of at least one photodiode 25 and a scintillator 26. The exposure sensor 24 is connected to an exposure control 28 via connecting lines 27.

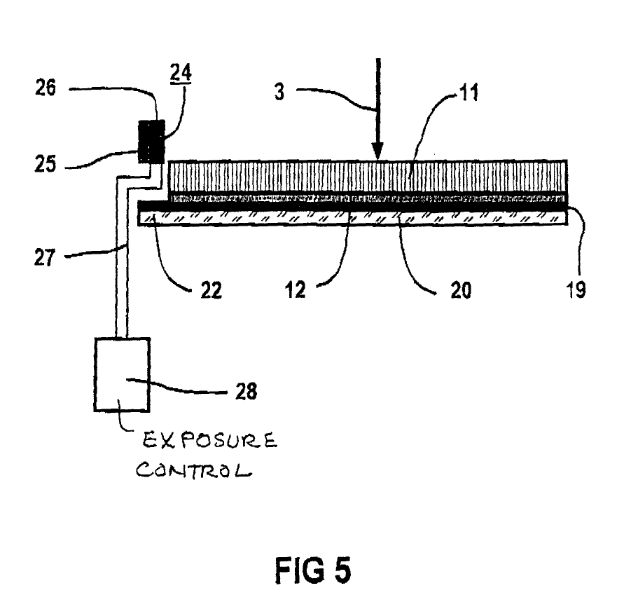

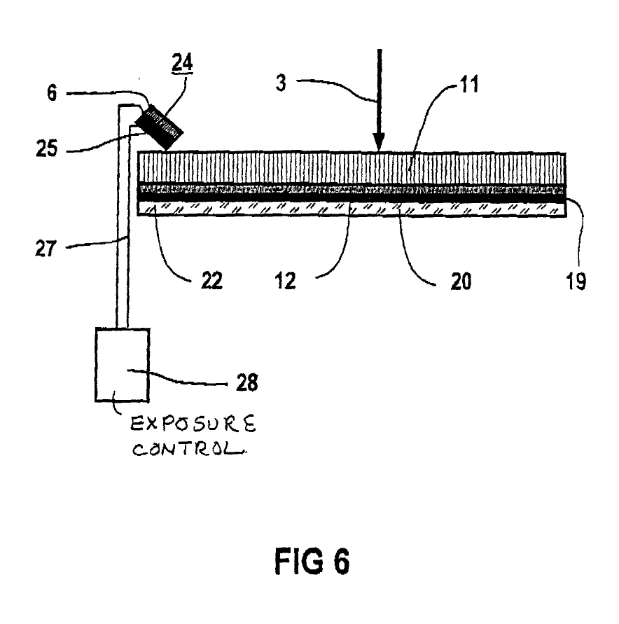

As shown in FIG. 4, the exposure sensor 24 can be aligned parallel to the pixel matrix 12 of the solid-state image converter 23. The exposure sensor 24, however, can also be arranged perpendicular (FIG. 5) or obliquely relative to the pixel matrix 12 of the solid-state image converter 23 (FIG. 6), for example at an angle of 45°.

As shown as an example In FIG. 6, however, the pixel matrix 12 of the solid-state image converter also can be fashioned up to the chest wall-proximate lateral region 22, so that the exposure sensor 24 is arranged in front of the pixel matrix 12 that, however, is not active in the chest wall-proximate lateral region 22, at least in the occlusion region of the exposure sensor 24.

The principle can also be utilized for a solid-state image converter 5 that employs other materials or principles. For example, the absorbent layer can be composed of a material such as amorphous selenium, lead iodide or lead oxide, wherein charge carriers are directly generated given incidence of X-rays and the presence of a suitable electrical field These charge carriers are detected in a pixel matrix situated thereunder. This pixel matrix can be composed of amorphous silicon (a-Si:H), whereby each pixel is essentially composed of an electrode, a collecting capacitor and a switch.

Although modifications and changes may be suggested by those skilled in the art, it is the intention of the inventor to embody within the patent warranted hereon all changes and modifications as reasonably and properly come within the scope of his contribution to the art.

I claim as my invention:

1. A planar image detector for electromagnetic rays for producing an image from said electromagnetic rays, comprising:
a substrate having an active surface formed by a matrix of radiation-sensitive pixel elements in an imaging procedure subject to exposure control, said active surface being adapted to receive radiation attenuated by an examination subject; and
a radiation-sensitive sensor disposed immediately next to said active area and also adapted to receive said radiation attenuated by said examination subject, for generating a control signal for said exposure control dependent on said radiation attenuated by an examination subject incident on said radiation-sensitive sensor.

2. A planar image detector as claimed in claim 1 wherein said substrate has a lateral region adapted for placement against a chest wall in a mammographic imaging procedure, and wherein said radiation-sensitive sensor is disposed at said lateral region.

3. A planar image detector as claimed in claim 2 wherein said radiation-sensitive sensor is centered at said lateral region.

4. A planar image detector as claimed in claim 2 wherein said radiation-sensitive sensor comprises a plurality of photoelements disposed in a row at said lateral region adapted to be occluded by said examination subject.

5. A planar image detector as claimed in claim 4 further comprising a circuit connected to said photoelements for selecting output signals from said photoelements.

6. A planar image detector as claimed in claim 1 wherein said radiation-sensitive sensor has a base area disposed parallel to said matrix of pixel elements.

7. A planar image detector as claimed in claim 1 wherein said radiation-sensitive sensor has a base area disposed perpendicular to said matrix of pixel elements.

8. A planar image detector as claimed in claim 1 wherein said radiation-sensitive sensor has a base area disposed obliquely to said matrix of pixel elements.

9. A planar image detector as claimed in claim 1 wherein said radiation-sensitive sensor comprises at least one photoelement composed of a photodiode and a scintillator applied on said photodiode.

10. A planar image detector as claimed in claim 9 wherein said photodiode is composed of crystalline silicon.

11. A planar image detector as claimed in claim 1 wherein said radiation-sensitive sensor comprises at least one photoelement composed of a photodiode and a photosemiconductor applied on said photodiode.

12. A planar image detector as claimed in claim 1 wherein said matrix of pixel elements comprises a layer of amorphous silicon on said substrate.

13. A planar image detector as claimed in claim 1 wherein said matrix of pixel elements comprises a layer of crystalline silicon on said substrate.

14. A planar image detector as claimed in claim 1 further comprising a stray radiation grid attached in front of said radiation-sensitive sensor.

15. A planar image detector as claimed in claim 1 further comprising a moving stray-radiation grid disposed over said matrix of pixel elements and radiation-sensitive sensor.
